(19) United States
(12) Patent Application Publication
(10) Pub. No.: US 2021/0358052 A1
(43) Pub. Date: Nov. 18, 2021

(54) METHOD FOR MEASURING WORK UNIT PRICE OF CROWDSOURCING-BASED PROJECT

(71) Applicant: CROWDWORKS INC., Seoul (KR)

(72) Inventors: Min Woo PARK, Gyeonggi-do (KR); Ju Yeong KIM, Seoul (KR)

(21) Appl. No.: 17/390,543

(22) Filed: Jul. 30, 2021

Related U.S. Application Data
(63) Continuation of application No. PCT/KR2020/006487, filed on May 18, 2020.

(30) Foreign Application Priority Data
May 22, 2019 (KR) 10-2019-0059825

(51) Int. Cl. G06Q 40/00; G06Q 10/10; G06Q 30/02; G06Q 10/06

(52) U.S. Cl. CPC G06Q 40/125; G06Q 10/103; G06Q 10/06312; G06Q 30/0284; G06Q 10/1091

(57) ABSTRACT

Provided is a method of measuring a work unit price of a crowdsourcing-based project, the method including: identifying a plurality of functional tools applied to tasks of a project scheduled to be opened; extracting, for each of the functional tools, previous project history information in which a corresponding functional tool is used; calculating working hours for each of the functional tools, on the basis of the previous project history information; calculating total working hours taken for one task of the project scheduled to be opened by summing the working hours for the respective functional tools; and measuring a work unit price of the project scheduled to be opened, on the basis of the total working hours.

### TECHNICAL FIELD

The present disclosure relates to a method of measuring a work unit price of a crowdsourcing-based project.

### BACKGROUND ART

Recently, more and more companies have been collecting and processing large amounts of data based on crowdsourcing that engages the general public in some processes of company activities. A company engages the general public in some processes of the company's activities, and, in return for this, pays costs according to a work unit price.

Here, as a method of measuring a work unit price, there is a method of measuring a work unit price by measuring working hours on the basis of the final submitted work. In detail, a work unit price is measured by measuring working hours for one task by making a plurality of workers work during the same hours and recording the number of tasks performed during set hours, or by recording completion hours for ten tasks to measure working hours per one.

However, this method does not consider the abilities of respective workers, and thus, working hours may vary significantly according to the abilities of workers, thereby making accurate measurement of a unit price uneasy.

Also, as various and many workers are given work to accurately measure a unit price, additional costs occur outside the work. Therefore, companies need to bear high costs.

In addition, when the work is rejected and corrected, working hours for the correction work needs to be re-measured, thereby causing additional costs for measurement of a work unit price.

### DESCRIPTION OF EMBODIMENTS

### Technical Problem

Provided is a method of measuring a work unit price of a crowdsourcing-based project, capable of measuring a work unit price by measuring working hours for respective functional elements needed for a task of a project and summing the working hours of the respective functional elements, rather than an existing method of measuring working hours on the basis of the final submitted work.

The problems to be solved by the present disclosure are not limited to the problems mentioned above, and unmentioned other problems may be clearly understood by one of ordinary skill in the art from the following description.

### Solution to Problem

According to an aspect of the present disclosure, a method of measuring a work unit price of a crowdsourcing-based project may include: identifying a plurality of functional tools applied to tasks of a project scheduled to be opened; extracting, for each of the functional tools, previous project history information in which a corresponding functional tool is used; calculating working hours for each of the functional tools, on the basis of the previous project history information; calculating total working hours taken for one task of the project scheduled to be opened by summing the working hours for the respective functional tools; and measuring a work unit price of the project scheduled to be opened, on the basis of the total working hours

The previous project history information may include at least one of total working hours for which a corresponding functional tool is used in a previous project, a total number of tasks, average working hours, a number of rejections, working hours of a rejected task, and working hours considering the number of rejections.

The total working hours may be generated by recording a start time and an end time of use of a particular functional tool in the previous project.

The average working hours may be a value obtained by dividing the total working hours by the total number of tasks.

The working hours of the rejected task may be a value obtained by multiplying the number of rejections by the average working hours.

The working hours considering the number of rejections may be a value obtained by summing the total working hours and the working hours of the rejected task.

Working hours for each of the functional tools may be a value obtained by dividing the working hours considering the number of rejections by the total number of tasks.

When n previous projects (wherein n is a natural number) use a particular functional tool, working hours for the particular functional tool may be a value obtained by dividing a value obtained by adding working hours considering a number n of rejections by a value obtained by adding a total number n of tasks.

The measuring the work unit price of the project scheduled to be opened may include: calculating a number of tasks of the project scheduled to be opened that may be worked per hour, on the basis of the total working hours taken for one task of the project scheduled to be opened; and dividing a lowest hourly wage by the calculated number of tasks of the project scheduled to be opened that may be worked per hour.

According to another aspect of the present disclosure, a program for measuring a work unit price of a crowdsourcing-based project may be combined with a computer that is hardware to execute a method of measuring a work unit price of a crowdsourcing-based project, and may be stored in a medium.

Other detailed matters of the present disclosure are included in the description and drawings.

### Advantageous Effects of Disclosure

According to the present disclosure described above, the following effects may be obtained by using use history data in a previous project for each work functional tool applied to a project scheduled to be opened.

A cost reduction effect may be obtained by eliminating additional costs needed for worker preparation and testing for measurement of a unit price.

Also, since only the ability of a selected worker is not significantly considered, quantitative measurement of a unit price may be made.

In addition, even when the work is rejected and corrected, additional costs needed for re-measuring working hours for the correction work may not occur.

Moreover, a work unit price may be re-measured at any time on the current basis. In other words, even though a use history of a particular functional tool is changed, the corresponding change may be immediately applied to measure a unit price.

The effects of the present disclosure are not limited to the effects mentioned above, and unmentioned other effects may be clearly understood by one of ordinary skill in the art from the following description.

### BRIEF DESCRIPTION OF DRAWINGS

FIG. 1 is a flowchart of a method of measuring a work unit price of a crowdsourcing-based project, according to an embodiment of the present disclosure.

FIG. 2 is an example view illustrating a task of a project to which a plurality of functional tools are applied, according to an embodiment of the present disclosure.

FIG. 3 is an example view illustrating the extraction of a previous project in which respective functional tools applied to a project scheduled to be opened are used, according to an embodiment of the present disclosure.

FIGS. 4 through 6 are example views each illustrating the calculating of working hours for each functional tool, according to an embodiment of the present disclosure.

FIG. 7 is a block diagram of an apparatus for measuring a work unit price of a crowdsourcing-based project, according to an embodiment of the present disclosure.

### MODE OF DISCLOSURE

Advantages and features of the disclosure, and methods of achieving thereof will become apparent with reference to the embodiments described below in detail in conjunction with the accompanying drawings. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art, and the disclosure is merely defined by the scope of claims.

The terminology used herein is for the purpose of describing the embodiments and is not intended to limit the disclosure. As used herein, the singular forms are intended to include the plural forms as well, unless the context clearly indicates otherwise. The terms “comprises” and/or “comprising” when used in this specification do not preclude the presence or addition of one or more other elements in addition to stated elements. Like reference numerals refer to like elements throughout. As used herein, the term “and/or” includes any and all combinations of one or more of the associated listed items. Although the terms “first,” “second,” etc. may be used herein to describe various elements or components, these elements or components should not be limited by these terms. These terms are only used to distinguish one element or component from another element or component. Thus, a first element or component discussed below may be termed a second element or component without departing from the scope of example embodiments.

Unless otherwise defined, all terms (including technical and scientific terms) used herein have the same meanings as commonly understood by one of ordinary skill in the art to which example embodiments belong. Terms, such as those defined in commonly used dictionaries, will not be interpreted in an idealized or overly formal sense unless expressly so defined herein.

Hereinafter, embodiments of the present disclosure will be described in detail with reference to the accompanying drawings.

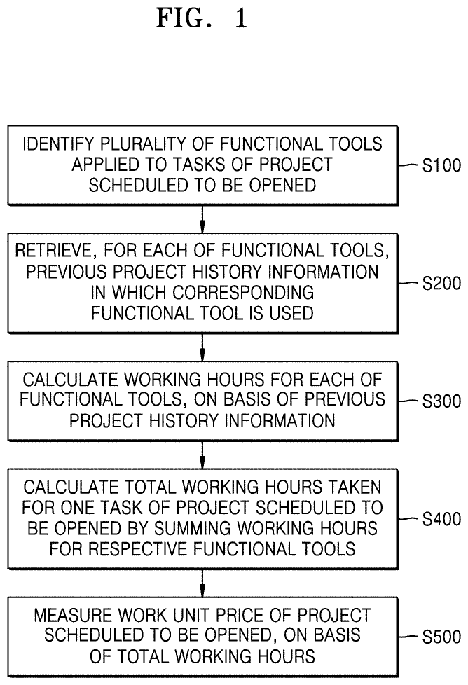

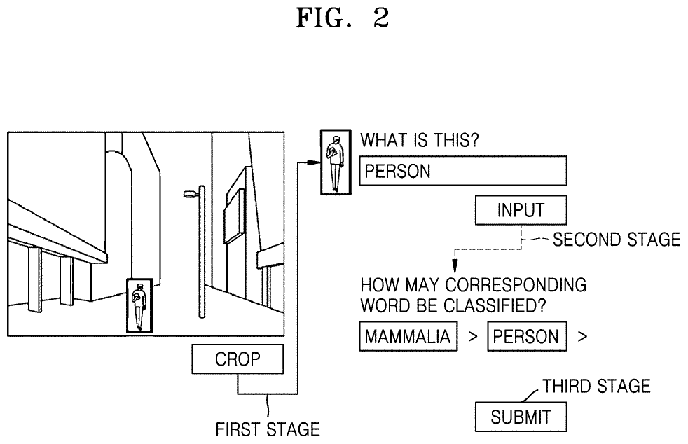

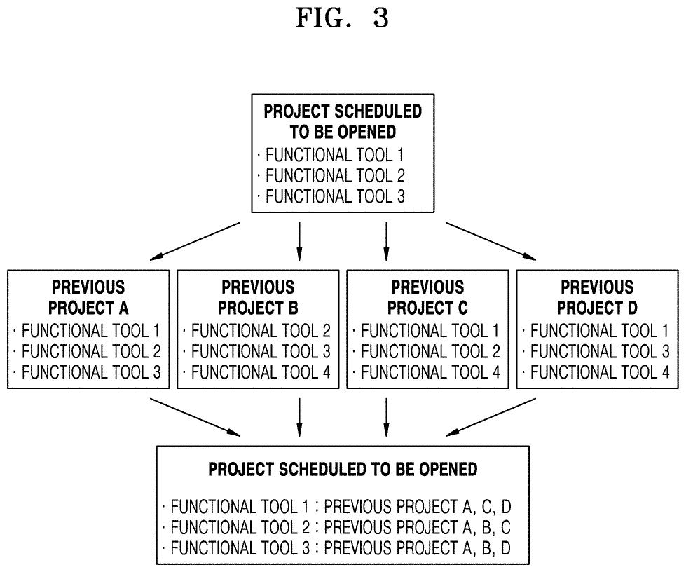

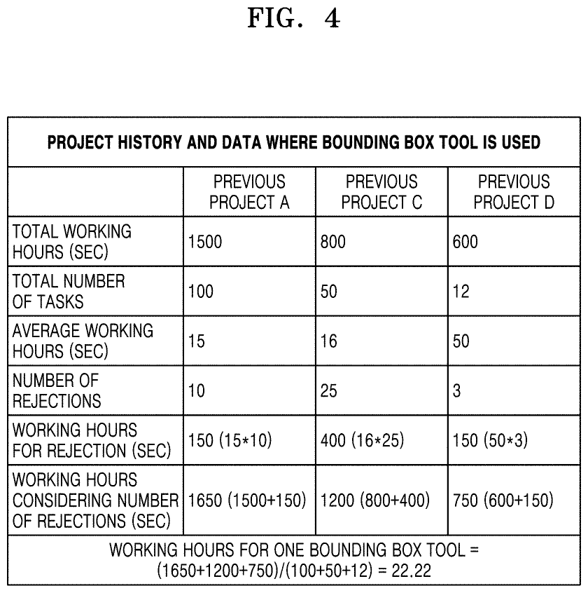

FIG. 1 is a flowchart of a method of measuring a work unit price of a crowdsourcing-based project, according to an embodiment of the present disclosure. FIG. 2 is an example view illustrating a task of a project to which a plurality of functional tools are applied, according to an embodiment of the present disclosure. FIG. 3 is an example view illustrating the extraction of a previous project in which respective functional tools applied to a project scheduled to be opened are used, according to an embodiment of the present disclosure. FIGS. 4 through 6 are example views each illustrating the calculating of working hours for each functional tool, according to an embodiment of the present disclosure.

A project scheduled to be opened according to the present disclosure refers to a crowdsourcing-based project planned by a company, or a project commissioned from a customer by a crowdsourcing service company. The company or the crowdsourcing service company needs to measure a work unit price for a corresponding project before opening the project. In other words, a company that plans a project or a service company that provides a crowdsourcing service may measure a work unit price of a project scheduled to be opened by performing respective operations S100 through S500 shown in FIG. 1. Here, it may be understood that respective operations S100 through S500 shown in FIG. 1 are performed by a server of the company that plans a project or a server of the service company that provides a crowdsourcing service, but the operations are not limited thereto.

Referring to FIG. 1, in operation S100, the server identifies a plurality of functional tools applied to a task of a project scheduled to be opened. In other words, the server needs to identify types of functional tools used to perform the task of the project to be scheduled. Here, the project refers to a crowdsourcing-based project that is completed by collecting a plurality of work results provided by a plurality of workers by performing respective tasks.

According to an embodiment, the work of a project may be completed via a plurality of functional tasks. In other words, workers who participate in a project may complete one task by performing a plurality of stages. Referring to FIG. 2, a worker needs to perform a first stage, a second stage, and a third stage to perform a task of a corresponding project.

In detail, a worker may perform a first stage, i.e., a bounding task, by selecting a particular object from a particular image (an image provided by a company that plans a project to perform the task of the project, or a service company that provides a crowdsourcing service). Here, the worker may use a bounding box tool to perform the bounding task.

The worker may perform a second stage, i.e., a transfer task, by inputting the selected particular object. Here, the worker may use an input box tool to perform the transfer task.

The worker may perform a third stage, i.e., an attribute classification task, by selecting a high-level concept including a word input in the transfer stage to classify a type of the particular object that is given a name. Here, the worker may use a make step tool to perform the attribute classification task.

Referring to FIG. 1, in operation S200, the server extracts, for each functional tool, previous project history information used in which a corresponding functional tool is used. For example, when a functional tool 1, a functional tool 2, and a functional tool 3 are used in a project scheduled to be opened, projects in which the functional tool 1, the second functional tool 2, and the third functional tool 3 are used are extracted from among previously performed projects. History information of previous projects used for respective functional tools are extracted.

Referring to FIG. 3, when a functional tool 1, a functional tool 2, and a functional tool 3 are applied to in a project scheduled to be opened, projects to which the functional tool 1, the functional tool 2, and the functional tool 3 are applied may be extracted from among previously performed projects. In detail, a previous project A applies the functional tool 1, the functional tool 2, and the functional tool 3, a previous project B applies the functional tool 2, the functional tool 3, and a functional tool 4, a previous project C applies the functional tool 1, the functional tool 2, and the functional tool 4, and a previous project D applies the functional tool 1, the functional tool 3, and the functional toll 4.

Accordingly, history information of the previous project A, the previous project C, and the previous project D is extracted for the functional tool 1 applied to the project scheduled to be opened, history information of the previous project A, the previous project B, and the previous project C is extracted for the functional tool 2, and history information of the previous project A, the previous project B, and the previous project D is extracted for the third functional tool 3.

Referring to FIG. 1, in operation S300, working hours for each functional tool are calculated on the basis of the previous project history information. Here, the previous project history information may include at least one of total working hours for which a corresponding functional tool is used in a previous project, the total number of tasks, average working hours, the number of rejections, working hours of a rejected task, and working hours considering the number of rejections. Working hours may be calculated for each functional tool by using such previous projection history information.

In detail, working hours for a functional tool are generated on the basis of information about accumulated time for which the corresponding functional tool is used by a plurality of users from the time when a previous project is opened to the time when the project is ended, the number of work results completed from the time when the previous project is opened to the time when the previous project is ended, average working hours resulting therefrom, the number of tasks that are rejected during the work, reworking hours for a rejected task, and working hours considering the reworking hours.

Here, the total working hours are generated by recording a start time and an end time of use of a particular functional tool in a previous project, and may refer to total hours that are obtained by summing hours for which a plurality of workers participating in the previous projects use the corresponding functional tool. Also, the total number of tasks may refer to final work results provided by a plurality of workers. In addition, the number of rejections refers to the number of times a task submitted by a worker is rejected by a project manager (e.g., an inspector) during a project. Here, the worker reworks and re-submits the rejected task. Here, the rejected task is not included in the total number of tasks, and, when one task is rejected several times, the rejected task is included as one task in the total number of tasks.

According to an embodiment, average working times (sec) refer to a value obtained by dividing total working hours (sec) by the total number of tasks, working hours (sec) of a rejected task refer to a value obtained by multiplying the number of rejections by average working hours (sec), and working hours (sec) considering the number of rejections refer to a value obtained by summing the working hours (sec) of the rejected task.

Accordingly, working hours (sec) per functional tool may be calculated by dividing the working hours (sec) considering the number of rejections by the number of tasks. Here, when n previous projects (wherein n is a natural number) use a particular functional tool, working hours of the particular functional tool may be calculated by dividing a value obtained by adding working hours considering the n number of rejections by a value obtained by adding the n total number of tasks.

According to an embodiment, a project scheduled to be opened may include, as functional tools to used, a bounding box tool for a bounding task, an input box tool for a transfer task, and a make step tool for an attribute classification task.

Referring to FIG. 4, history information of a previous project A, a previous project C, and a previous project D for a bounding box tool may be extracted.

In the previous project A, when total working hours for which the bounding box tool is used are 1500 sec., and the total number of tasks is 100, average working hours are 15 sec. Also, because the number of rejections is 10, working hours of a rejected task is 150 sec. that is a value obtained by multiplying average working hours by the number of rejections. Therefore, total working hours for which the bounding box tool is used in the previous project A (i.e., working hours considering the number of rejections) are 1650 sec.

Also, in the previous project C, when total working hours for which the bounding box tool is used are 800 sec, and the total number of tasks is 50, average working hours are 16 sec. Also, because the number of rejections is 25, working hours of a rejected task are 400 sec that is a value obtained by multiplying the average working hours by the number of rejections. Therefore, total working hours for which the bounding box tool is used in the previous project C (i.e., working hours considering the number of rejections) are 1200 sec.

Also, in the previous project D, when total working hours for which the bounding box tool is used are 600 sec, and the total number of tasks is 12, average working hours are 50 sec. Also, because the number of rejections is 3, working hours of a rejected task are 150 sec that is a value obtained by multiplying the average working hours by the number of rejections. Therefore, total working hours for which the bounding box tool is used in the previous project D (i.e., the working hours considering the number of rejections) are 750 sec.

Accordingly, average hours for which one task is performed by using the bounding box tool are a value obtained by dividing a value obtained by adding the working hours of the previous project A considering the number of rejections, the working hours of the previous project C considering the number of rejections, and the working hours of the previous project D considering the number of rejections by a value obtained by adding the total number of tasks of the previous project A, the total number of tasks of the previous project C, and the total number of tasks of the previous project D, i.e., (1650+1200+750)/(100+50+12)=22.22 sec.

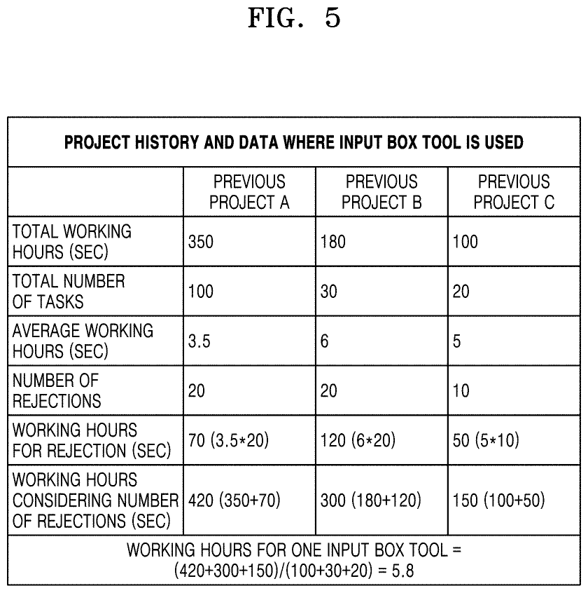

Referring to FIG. 5, history information of a previous project A, a previous project B, and a previous project C for an input box tool may be extracted.

In the previous project A, when total working hours for which the input box tool is used are 350 sec, and the total number of tasks is 100, average working hours are 3.5 sec. Also, because the number of rejections is 20, working hours of a rejected task are 70 sec that is a value obtained by multiplying the average working hours by the number of rejections. Therefore, total working hours for which the input box tool is used in the previous project A (i.e., working hours considering the number of rejections) are 420 sec.

Also, in the previous project B, when total working hours for which the input box tool is used are 1800 sec, and the total number of tasks is 30, average working hours are 6 sec. In addition, because the number of rejections is 20, working hours of a rejected task are 120 sec that is a value obtained by multiplying the average working hours by the number of rejections. Therefore, total working hours for which the input box tool is used in the previous project B (i.e., working hours considering the number of rejections) are 300 sec.

In addition, in the previous project C, when total working hours for which the input box tool is used are 100 sec, and the total number of tasks is 20, average working hours are 5 sec. Also, because the number of rejections is 10, working hours of a rejected task are 50 sec that is a value obtained by multiplying the average working hours by the number of rejections. Therefore, total working hours for which the bounding box tool is used in the previous project C (i.e., working hours considering the number of rejections) are 150 sec.

Accordingly, average hours for which one task is performed by using the input box tool are a value obtained by dividing a value obtained by adding the working hours of the previous project A considering the number of rejections, the working hours of the previous project B considering the number of rejections, and the working hours of the previous project C considering the number of rejections by a value obtained by adding the total number of tasks of the previous project A, the total number of tasks of the previous project B, and the total number of tasks of the previous project C, i.e., (420+300+150)/(100+30+20)=5.8 sec.

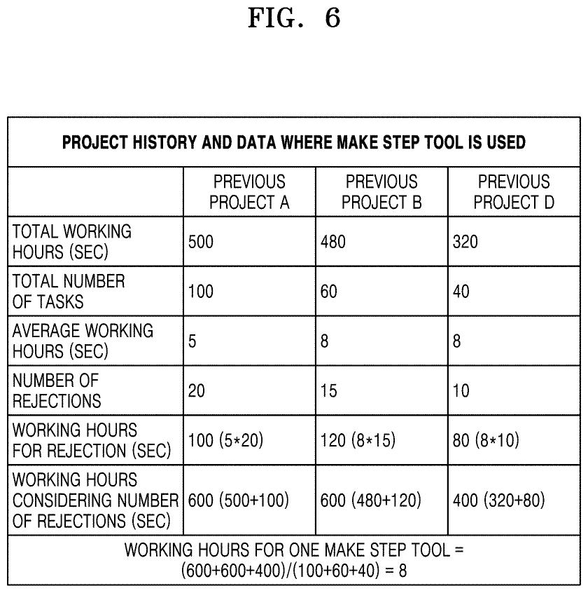

Referring to FIG. 6, history information of a previous project A, a previous project B, and a previous project D for a make step tool may be extracted.

In the previous project A, when total working hours for which the make step tool is used are 500 sec, and the total number of tasks 100, average working hours are 5 sec. In addition, because the number of rejections is 20, working hours of a rejected task are 100 sec that is a value obtained by multiplying the average working hours by the number of rejections. Therefore, total working hours for which the make step tool is used in the previous project A (i.e., working hours considering the number of rejections) are 600 sec.

Also, in the previous project B, when total working hours for which the make step tool is used are 480 sec, and the total number of tasks is 60, average working hours are 8 sec. In addition, because the number of rejections is 15, working hours of a rejected task are 120 sec that is a value obtained by multiplying the average working hours by the number of rejections. Therefore, total working hours for which the make step tool is used in the previous project B (i.e., working hours considering the number of rejections) are 600 sec.

In addition, in the previous project D, when total working hours for which the make step tool is used are 320 sec, and the total number of tasks is 40, average working hours are 8 sec. Also, because the number of rejections is 10, working hours of a rejected task are 80 sec that is a value obtained by multiplying the average working hours by the number of rejections. Accordingly, total working hours for which the make step tool is used in the previous project D (i.e., working hours considering the number of rejections) are 400 sec.

Accordingly, average hours for which one task is performed by using the make step tool are a value obtained by dividing a value obtained by adding the working hours of the previous project A considering the number of rejections, the working hours of the previous project B considering the number of rejections, and the working hours of the previous project D considering the number of rejections by a value obtained by adding the total number of tasks of the previous project A, the total number of tasks of the previous project B, and the total number of tasks of the previous project D, i.e., (600+600+400)/(100+60+40)=8 sec.

In operation S400, total working hours taken for one task of the project scheduled to be opened are calculated by summing working hours for respective functional tools. In other words, working hours estimated for performing tasks of a project scheduled to be opened may be measured by adding average working hours of respective functional tools generated on the basis of previous project history information for the respective functional tools.

For example, when a project scheduled to be opened applies a functional tool 1, a functional tool 2, and a functional tool 3, average working hours for the functional tool 1 are 22.22 sec, average working hours for the functional tool 2 are 5.8 sec, and average working hours for the functional tool 3 are 8 sec, working hours estimated per one task of the project scheduled to be opened are 22.22+5.8+8=36 sec. In other words, 36 sec may be averagely taken to perform one task of the project scheduled to be opened.

In operation S500, a work unit price of the project scheduled to be opened is measured on the basis of the total working hours. In other words, the work unit price of the project scheduled to be opened may be measured by calculating the number of tasks of the project scheduled to be opened that may be worked per hour, on the basis of total working hours taken per one task of the project scheduled to be opened, and dividing a lowest hourly wage by the calculated number of tasks of the project scheduled to be opened that may be worked per hour.

For example, when 36 sec are taken for performing one task of the project scheduled to be opened, 100 tasks may be performed in an hour. Accordingly, when the lowest hourly wage (e.g., 8,350 won) is divided by 100, an appropriate work unit price is measured to be 83 won or 84 won.

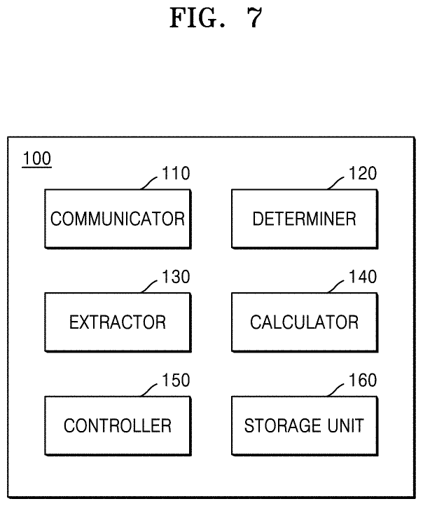

FIG. 7 is a block diagram of an apparatus for measuring a work unit price of a crowdsourcing-based project, according to an embodiment of the present disclosure.

Referring to FIG. 7, an apparatus 100 for measuring a work unit price of a crowdsourcing-based project (hereinafter, a work unit price measurement apparatus) includes a communicator 110, a determiner 120, an extractor 130, a calculator 140, a controller 150, and a storage unit 160.

The communicator 110 transmits and receives data by communicating with at least one of a terminal of a client, a terminal of a worker, and a terminal of a manager.

The determiner 120 identifies a plurality of functional tools applied to tasks of a project scheduled to be opened.

The extractor 130 retrieves and extracts, for the plurality of functional tools identified by the determiner 120, previous project history information in which each of the plurality of functional tools is used

The calculator 140 calculates average working hours for each of the functional tools, on the basis of the previous project history information for each of the functional tools extracted by the extractor 130. Also, the calculator 140 calculates total working hours taken for one task of the project scheduled to be opened by adding the average working hours for the respective functional tools, and, on the basis of same, measures a work unit price of the project scheduled to be opened.

The controller 150 controls each of components of the work unit price measurement apparatus 100.

The storage unit 160 stores and manages data received by the work unit price measurement apparatus 100, data generated by the work unit price measurement apparatus 100, and the like.

A method of measuring a work unit price of a crowdsourcing-based project according to an embodiment of the present disclosure, as described above, may be implemented as a program (or an application) and stored in a medium to be combined with a computer that is hardware to be executed.

In order for the computer to read the program and execute the methods implemented as the program, the above-described program may include a code written in a computer language such as C, C++, JAVA, Ruby, and machine language that may be read by a processor (CPU) of the computer via a device interface of the computer. Such code may include functional code related to a function that defines functions needed for executing the above methods and the like, and may include execution procedure-related control code needed for the processor of the computer to execute the functions according to a preset procedure. Also, such code may further include memory reference-related code indicating a location (address) in an internal or external memory of the computer at which additional information or media needed for the processor of the computer to execute the functions may be referred to. Also, when the processor of the computer needs to communicate with any other computer or server at a remote location to execute the functions, the code may further include communication-related code indicating a method of communicating with any other computer or server at a remote location by using a communication module of the computer, and information or media that is transmitted and/or received during communication and the like.

The storage medium refers to a medium that stores data semi-permanently and may be read by a device, rather than a medium that stores data for a short moment, such as a register, a cache, or a memory. In detail, examples of the storage medium include ROM, RAM, CD-ROMs, magnetic tape, floppy disks, optical data storage devices, and the like but are not limited thereto. In other words, the program may be stored in various types of recording media on various servers that may be accessed by the computer or in various types of recording media on the computer of a user. Also, the media may be distributed over network-coupled computer systems so that computer-readable code is stored in a distributed fashion.

The foregoing description of the disclosure is for purposes of illustration, and those of ordinary skill in the art to which the disclosure pertains may understand that it may be easily modified into other specific forms without changing the technical spirit or essential features of the disclosure. Therefore, it may be understood that the embodiments described above are illustrative in all respects and not restrictive.

1. A method of measuring a work unit price of a crowdsourcing-based project, the method comprising:
identifying a plurality of functional tools applied to tasks of a project scheduled to be opened;
extracting, for each of the functional tools, previous project history information in which a corresponding functional tool is used;
calculating working hours for each of the functional tools, on the basis of the previous project history information;
calculating total working hours taken for one task of the project scheduled to be opened by summing the working hours for the respective functional tools; and
measuring a work unit price of the project scheduled to be opened, on the basis of the total working hours,
wherein the functional tools are provided by the crowdsourcing-based project, and are used to perform the work required by the crowdsourcing-based project,
wherein the previous project history information includes at least one of total working hours for which a corresponding functional tool is used in a previous project, a total number of tasks, average working hours, a number of rejections, working hours of a rejected task, and working hours considering the number of rejections.

2. The method of claim 1, wherein the total working hours are generated by recording a start time and an end time of use of a particular functional tool in the previous project.

3. The method of claim 1, wherein the average working hours are a value obtained by dividing the total working hours by the total number of tasks.

4. The method of claim 3, wherein the working hours of the rejected task are a value obtained by multiplying the number of rejections by the average working hours.

5. The method of claim 4, wherein the working hours considering the number of rejections are a value obtained by summing the total working hours and the working hours of the rejected task.

6. The method of claim 5, wherein working hours for each of the functional tools are a value obtained by dividing the working hours considering the number of rejections by the total number of tasks.

7. The method of claim 6, wherein when n previous projects (wherein n is a natural number) use a particular functional tool, working hours for the particular functional tool are a value obtained by dividing a value obtained by adding working hours considering a number n of rejections by a value obtained by adding a total number n of tasks.

8. The method of claim 1, wherein the measuring the work unit price of the project scheduled to be opened includes:
calculating a number of tasks of the project scheduled to be opened that may be worked per hour, on the basis of the total working hours taken for one task of the project scheduled to be opened; and
dividing a lowest hourly wage by the calculated number of tasks of the project scheduled to be opened that may be worked per hour.

9. A non-transitory computer program stored in a computer-readable recording medium to be combined with a computer to execute the method of claim 1 of measuring a work unit price of a crowdsourcing-based project.
